(19) United States
(12) Patent Application Publication
(10) Pub. No.: US 2018/0002225 A1
(43) Pub. Date: Jan. 4, 2018

(54) BINDER FOR MINERAL FIBRES, COMPRISING LIGNOSULFONATE AND A CARBONYL COMPOUND, AND RESULTING MATS

(71) Applicants: SAINT-GOBAIN ADFORS, Chambery (FR); INSTITUT NATIONAL DE LA RECHERCHE AGRONOMIQUE, Paris (FR)

(72) Inventors: Florent ALLAIS, Reims (FR); Paul-Henri DUCROT, Igny (FR); Orianne BROUSSARD, Orsay (FR); Morgane PETIT, Paris (FR); Christelle SILIOC, Bourg La Reine (FR)

(21) Appl. No.: 15/547,205

(22) PCT Filed: Feb. 1, 2016
(86) PCT No.: PCT/FR2016/050204

§ 371 Date: Jul. 28, 2017

(30) Foreign Application Priority Data
Jan. 30, 2015 (FR) 1550717
Jan. 30, 2015 (FR) 1550719

(51) Int. Cl. C03C 25/34; C08L 97/00

(52) U.S. Cl. CPC C03C 25/34; C08L 97/00; C08L 2205/03; C08L 2201/54

(57) ABSTRACT

An aqueous binder for mineral fibers, in particular glass fibers, includes at least one ammonium lignosulfonate or one alkali metal or alkaline earth metal salt of lignosulfonic acid, and at least one carbonyl compound of formula: R—[C(O)R₁]ₓ (I) in which: R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups, in particular hydroxyl or alkoxy groups, especially methoxy groups, R₁ represents a hydrogen atom or a C₁-C₁₀ alkyl radical, and x varies 1 to 10, the binder being devoid of hydrogenated sugar and of melamine.

The present invention relates to the field of products comprising mineral fibers, in particular glass fibers, bonded by a formaldehyde-free organic binder.

The invention more particularly relates to an aqueous binder capable of crosslinking thermally which includes at least one lignosulfonate and at least one carbonyl compound, and also to the products based on mineral fibers which result therefrom.

The products based on mineral fibers to which the invention more particularly relates are mats of mineral fibers, in particular glass fibers, (also known as “nonwovens” or “veils”) which are manufactured according to known processes operating by the dry route or the wet route.

In the dry-route process, molten matter present in a furnace is conveyed toward a group of bushings from which filaments flow out by gravity and are drawn by a gaseous fluid. The continuous mineral filaments are collected on a conveyor, where they become entangled with the formation of a mat.

A binder is applied to the upper face of the mat thus formed using an appropriate device, generally operating by curtain coating, and the excess of binder is removed by suction on the opposite face. The mat subsequently enters a device containing hot air, the temperature of which, of the order of 200 to 250° C., is adjusted in order to remove the water and to crosslink the binder in a very short time, of the order of approximately ten seconds to 1 minute, and then the mat of mineral fibers is collected in the form of a roll.

In the wet-route process, the mat is obtained from an aqueous dispersion of cut mineral fibers which is deposited, by means of a forming head, on a conveyor provided with perforations and the water is extracted through the conveyor by virtue of a suction box. The cut mineral fibers remaining on the conveyor form a mat which is treated under the same conditions as those described for the dry-route process.

In the abovementioned processes, the role of the binder is to bind the mineral fibers to one another and to confer, on the mat in which they are present, mechanical properties suitable for the desired use, in particular a stiffness sufficient to allow it to be easily handled without risk that it may be torn.

The binder to be applied to the mineral fibers is generally provided in the form of an aqueous solution including at least one thermosetting resin and additives, such as a catalyst for the crosslinking of the resin, an adhesion-promoting silane, a water repellent, and the like.

The most commonly used thermosetting resins are formaldehyde-based resins, in particular phenolic resins belonging to the family of the resols, urea/formaldehyde resins and melamine/formaldehyde resins. These resins have good crosslinkability under the abovementioned thermal conditions, are soluble in water, have a good affinity for mineral fibers and are in addition relatively inexpensive.

However, these resins are liable to contain free formaldehyde, the presence of which is not desired as a result of the undesirable effects from the viewpoint of human health and the environment. For some years, regulations with regard to environmental protection have been becoming more restrictive and are forcing manufacturers of resin and fibrous products to look for solutions which make it possible to further lower the content of free formaldehyde.

Solutions in which formaldehyde-based resins for bonding mineral fibers are replaced are known and are based on the use of a carboxylic acid polymer in combination with a β-hydroxyamide and an at least trifunctional monomeric carboxylic acid (U.S. Pat. No. 5,340,868).

Adhesive compositions comprising an alkanolamine including at least two hydroxyl groups and a polycarboxylic polymer (U.S. Pat. No. 6,071,994, U.S. Pat. No. 6,099,773, U.S. Pat. No. 6,146,746, US 2002/091185) have been provided.

Adhesive compositions which comprise a polycarboxylic polymer, a polyol and a catalyst, which catalyst contains phosphorus (U.S. Pat. No. 5,318,990, U.S. Pat. No. 5,661,213, U.S. Pat. No. 6,331,350, US 2003/0008978), a fluoroborate (U.S. Pat. No. 5,977,232) or else a cyanamide, a dicyanamide or a cyanoguanidine (U.S. Pat. No. 5,932,689), have also been described.

Furthermore, adhesive compositions based on saccharides capable of crosslinking under the effect of heat are known.

In U.S. Pat. No. 5,895,804, the adhesive composition comprises a polycarboxylic polymer having at least two carboxylic acid functional groups and a molecular weight at least equal to 1000, and a polysaccharide having a molecular weight at least equal to 10 000.

Finally, WO 2012/172252 describes an aqueous formaldehyde-free binder for mats of fibers which comprises (in parts by weight): a lignosulfonic acid salt (20 to 95 parts), an oligosaccharide (5 to 80 parts) and a crosslinking catalyst chosen from phosphorus-containing compounds and sulfates (5 to 20 parts per 100 parts of lignosulfonic acid salt and of oligosaccharides).

The present invention is more particularly concerned with fibrous products based on mineral fibers, in particular glass fibers, which are provided in the form of mats. In particular, the targeted mats are intended for the manufacture of leaktight bituminous roofing membranes.

It is an aim of the present invention to provide an alternative to the binders liable to contain or to generate formaldehyde and which make it possible to confer good mechanical properties on mats based on mineral fibers, in particular an improved breaking stress.

This aim is achieved according to the invention by virtue of the aqueous binder for mineral fibers, in particular glass fibers, which comprises:
at least one ammonium lignosulfonate or one alkali metal or alkaline earth metal salt of lignosulfonic acid, and
at least one carbonyl compound of formula:

R—[C(O)R₁]ₓ (I)

in which:
R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups, in particular hydroxyl or alkoxy groups, especially methoxy groups,
R₁ represents a hydrogen atom or a C₁-C₁₀ alkyl radical, and
x varies 1 to 10,

said binder being devoid of hydrogenated sugar and of melamine.

Ammonium lignosulfonate is a byproduct resulting from the treatment of wood for the manufacture of paper pulp according to the “sulfite” process. The treatment of the paper pulp with ammonium sulfite or ammonium bisulfite makes it possible to obtain ammonium lignosulfonates.

In addition, ammonium lignosulfonate makes it possible to confer, on the binder, properties of resistance to fire.

The alkali metal or alkaline earth metal salts of lignosulfonic acid are generally complex mixtures of several lignosulfonic acids in the salified form, commonly denoted “lignosulfonates”. Lignosulfonates are byproducts resulting from the treatment of wood for the manufacture of paper pulp according to the abovementioned “sulfite” process which employs a sulfite or a bisulfite. According to the nature of the counterion of the sulfite or bisulfite employed, alkali metal or alkaline earth metal salts of lignosulfonic acid are obtained in particular. In the present invention, the preferred alkali metal salts of lignosulfonic acid are sodium or potassium, advantageously sodium, lignosulfonates, and the preferred alkaline earth metal salts of lignosulfonic acid are magnesium or calcium lignosulfonates.

The preferred carbonyl compound is an aldehyde corresponding to the formula (I) in which the R₁ radical represents a hydrogen atom and x is at most equal to 6.

The carbonyl functional group of the aldehyde can, in this case, exist in the form of an acetal or of a hemiacetal of following formula (II):

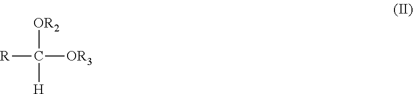

in which:
R₂ represents a C₁-C₁₀ alkyl radical, and
R₃ represents a hydrogen atom or a C₁-C₁₀ alkyl radical.

More preferably still, the carbonyl compound of formula (I) is a monofunctional or polyfunctional aldehyde chosen from the group consisting of acetaldehyde, propionaldehyde, dimethoxyethanal, butyraldehyde, in particular n-butyraldehyde, glyoxal, malonaldehyde, succinaldehyde, glutaraldehyde, 2-hydroxyglutaraldehyde, 3-methylglutaraldehyde, adipaldehyde, suberaldehyde, sebacaldehyde, malealdehyde, fumaraldehyde, poly(acroleins), dialdehyde starch, furfural (2-furancarboxyaldehyde), 5-methylfurfural (2-methyl-5-furancarboxyaldehyde), hydroxymethylfurfural (2-hydroxymethyl-5-furancarboxyaldehyde), 2,5-furancarboxydialdehyde, vanillin and vanillin polymers, in particular bis-vanillin, cinnamaldehyde and cinnamaldehyde polymers, phthalaldehyde, isophthalaldehyde, terephthalaldehyde and the oligomers of following formulae (III) and (IV):

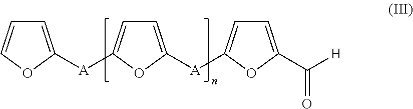

in which:
A represents a divalent —CH₂—, —CH(OH)— or —CH₂—O—CH₂— radical,
n varies from 1 to 8,

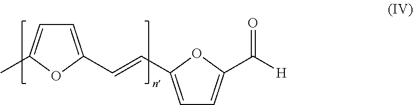

in which n′ varies from 1 to 9.

Hydroxymethylfurfural is particularly preferred.

In the binder, ammonium lignosulfonate or the alkali metal or alkaline earth metal salt of lignosulfonic acid generally represents from 30 to 95% of the weight of the mixture consisting of ammonium lignosulfonate or the alkali metal or alkaline earth metal salt of lignosulfonic acid and the carbonyl compound of formula (I), preferably from 40 to 80% and advantageously from 50 to 70%.

The binder can additionally comprise:
at least one vinyl acetate homopolymer or one copolymer of vinyl acetate and of at least one hydrophobic monomer, such as ethylene, propylene, butylene, styrene or vinyl chloride, preferably ethylene. The abovementioned homopolymer and abovementioned copolymer are generally present in an amount at most equal to 15 parts by weight per 100 parts by weight of ammonium lignosulfonate or of alkali metal or alkaline earth metal salt of lignosulfonic acid and of carbonyl compound of formula (I), and
at least one polysaccharide, for example a starch. The polysaccharide is generally present in an amount at most equal to 50 parts by weight per 100 parts by weight of ammonium lignosulfonate or of alkali metal or alkaline earth metal salt of lignosulfonic acid and of carbonyl compound (I).

When the binder contains ammonium lignosulfonate, it can additionally include at least one compound chosen from phosphorus-containing compounds and ammonium sulfate.

Mention may be made, by way of examples of phosphorus-containing compounds, of alkali metal hypophosphite salts, alkali metal phosphites, alkali metal polyphosphates, alkali metal hydrogenphosphates, phosphoric acids and alkylphosphonic acids, in which the alkali metal is preferably sodium or potassium, and ammonium phosphates, in particular diammonium phosphate. The content of abovementioned compound is at most equal to 20 parts by weight per 100 parts by weight of ammonium lignosulfonate and of carbonyl compound of formula (I).

The binder in accordance with the invention can also comprise the conventional additives below in the following proportions, calculated on the basis of 100 parts by weight of ammonium lignosulfonate or of alkali metal or alkaline earth metal salt of lignosulfonic acid and of carbonyl compound of formula (I):
0 to 1 part by weight of silane, preferably 0.1 to 0.5 part,
0 to 5 parts by weight of a silicone, of a vegetable oil or of a fluorinated compound, preferably 0.1 to 1 part, and
0 to 5 parts of a plasticizing agent, in particular glycerol.

The role of the additives is known and briefly restated: the silane is an agent for coupling between the fibers and the binder, and also acts as antiaging agent; the silicone, the vegetable oil and the fluorinated compound are water repellents, the role of which is to reduce the absorption of water by the mat of mineral fibers.

The binder is provided in the form of an aqueous solution.

When the binder contains ammonium lignosulfonate, the preferred silane is an aminosilane.

The binder containing an alkali metal or alkaline earth metal salt of lignosulfonic acid is devoid of nitrogenous compounds, which is advantageous as for this reason the gas emissions generated during the heat treatment targeted at crosslinking the binder do not contain nitrogen. The treatment of the waste products at the outlet of the drying oven in industrial plants is thus easier to carry out.

The binder is more particularly intended to be applied to mineral fibers formed from glass or from a rock, in particular basalt, and preferably from glass, in order to form a mat. The mat comprising mineral fibers bonded by the abovementioned binder constitutes another subject matter of the present invention.

Conventionally, the binder is deposited on a mat of mineral fibers (formed by the dry route or the wet route) and then the mat is treated at a temperature which makes possible the crosslinking of the binder, which then becomes infusible. The crosslinking of the binder according to the invention is generally carried out under conditions comparable to those of a conventional formaldehyde-containing resin, generally at a temperature which varies from 200 to 220° C. and for a very short period of time, of the order of a few seconds to 1 minute.

The mineral fibers are both mineral filaments and yarns composed of a multitude of mineral filaments bonded together, in particular by a size, and assemblies of such yarns. The mineral filaments and yarns can be continuous or discontinuous.

Thus, according to a first embodiment, the mat of mineral fibers is composed of discontinuous mineral filaments with a length which can reach 150 mm, preferably varying from 20 to 100 mm and advantageously from 50 to 70 mm, and which have a diameter which can vary within wide limits, for example from 5 to 30 μm.

According to a second embodiment, the mat of mineral fibers is composed of mineral yarns.

The mineral yarns can be yarns composed of a multitude of mineral filaments (or base yarns) or assemblies of these base yarns in the form of rovings.

The abovementioned yarns can be twist-free yarns or twisted yarns (or textile yarns), preferably twist-free yarns.

The mineral yarns, in particular glass yarns, are generally cut to a length which can range up to 100 mm, preferably varying from 6 to 30 mm, advantageously from 8 to 20 mm and better still from 10 to 18 mm.

The diameter of the glass filaments constituting the yarns can vary to a large extent, for example from 5 to 30 μm. In the same way, wide variations can occur in the linear density of the yarn, which can range from 34 to 1500 tex.

The glass participating in the composition of the filaments can be of any type, for example C, E, R or AR (alkali-resistant). The glass E or C is preferred.

Although the invention relates more particularly to mats consisting of mineral fibers, in particular of glass or rock fibers, as already mentioned, it cannot be ruled out for the mat to contain a small proportion of organic fibers, for example representing at most 20% of the weight of the mineral fibers.

The organic fibers can be synthetic fibers or natural fibers.

Mention may be made, as examples of synthetic fibers, of fibers consisting of a polyolefin, for example of polyethylene or polypropylene, of a polyalkylene terephthalate, for example polyethylene terephthalate, or of a polyester.

Mention may be made, as examples of natural fibers, of plant fibers, for example cotton, coconut, sisal, hemp or flax fibers, and animal fibers, for example silk or wool.

The mat of mineral fibers can, if appropriate, be reinforced by continuous fibers which are generally deposited on the device for conveying the mat in the direction of forward progression of the mat and are distributed over all or part of the width of the mat. These fibers are generally deposited in the thickness of the mat, before the application of the binder.

The reinforcing fibers can be mineral and/or organic fibers of the same chemical nature as the abovementioned fibers participating in the composition of the mat of fibers according to the invention.

The reinforcing fibers made of glass are preferred.

The mat of mineral fibers generally exhibits a weight per unit area which varies from 10 to 1100 g/m², preferably from 30 to 350 g/m² and advantageously from 35 to 75 g/m².

The binder generally represents from 5 to 40% by weight of the mat of mineral fibers, preferably from 10 to 30%.

The mat of mineral fibers in accordance with the present invention is more particularly intended for the preparation of leaktight bituminous membranes. However, the mat of mineral fibers can also be used in other applications, for example as wall and/or ceiling covering (to be or not to be painted), surface or sealing covering for gypsum board or cement board, surface covering for thermal and/or sound insulation products, such as a mineral wool or a foam intended more particularly for the insulation of roofs, or for producing a floor covering, in particular an acoustic underlayer.

The examples which follow make it possible to illustrate the invention without, however, limiting it.

In these examples, the breaking stress of a 5 cm×25 cm sample attached at one end to a tensile testing machine and subjected to a continuous elongation of 40 mm/minute is measured. The breaking stress is expressed in N/5 cm.

The breaking stress is measured after the manufacture (initial) and after the sample has been treated under the following conditions (a) accelerated aging in a heated chamber at 50° C. under 98% relative humidity for 3 days, (b) treatment in water at 80° C. for 10 minutes. The result is expressed by the percentage of retention, which is equal to: (breaking stress after treatment/initial breaking stress)×100.

### EXAMPLES 1 TO 6

Aqueous binders comprising the constituents appearing in table 1 in proportions expressed as parts by weight of solids are prepared. The reference binder (denoted Ref.) is representative of the state of the art described in WO 2012/172252.

The binders are prepared by introducing the different constituents into a container containing water at ambient temperature, with moderate stirring.

The solids content (dry matter) of the binders is equal to 20%.

Use is made of a mat of filaments of glass E having a diameter of 13 μm and a length of 18 mm. The weight per unit area of the mat is equal to 75 g/m².

The mat is immersed in the binder for 30 seconds and then the excess is removed by suction. The mat is subsequently treated in a drying oven at 210° C. for 60 seconds. In the end, the mat contains 20% by weight of binder.

The properties of each mat are given in table 1.

Examples 1 to 3 have an initial breaking stress and a breaking stress after accelerated aging which are improved with respect to the Reference.

In addition, examples 2, 3 and 6 exhibit, after treatment with water, a better breaking stress with respect to the Reference.

TABLE 1

| | Ex. | Ex. | Ex. | Ex. | Ex. | Ex. | |
|---|---|---|---|---|---|---|---|
| | 1 | 2 | 3 | 4 | 5 | 6 | Ref. |
| Composition of the binder | | | | | | | |
| Ammonium lignosulfonate⁽¹⁾ | 95 | 80 | 60 | — | — | — | 60 |
| Sodium lignosulfonate⁽²⁾ | — | — | — | 80 | — | — | — |
| Magnesium lignosulfonate⁽³⁾ | — | — | — | — | 80 | — | — |
| Calcium lignosulfonate⁽⁴⁾ | — | — | — | — | — | 80 | — |
| Hydroxymethylfurfural | 5 | 20 | 40 | 20 | 20 | 20 | — |
| Glucose | — | — | — | — | — | — | 40 |
| Diammonium phosphate | — | — | — | — | — | — | 5 |
| Properties of the mat | | | | | | | |
| Breaking stress (N/5 cm) | | | | | | | |
| Initial | 40 | 63 | 80 | 42 | 62 | 48 | 30 |
| After accelerated aging (a) | 48 | 61 | 77 | 2 | 3 | 41 | 27 |
| % retention | 121 | 98 | 96 | 5 | 5 | 86 | 90 |
| After treatment with water (b) | 0 | 14 | 33 | 0 | 0 | 29 | 11 |
| % retention | 0 | 22 | 41 | 0 | 0 | 60 | 37 |

⁽¹⁾T11N5, sold by Tembec
⁽²⁾Arbo N18, sold by Tembec
⁽³⁾Arbo MGLS, sold by Tembec
⁽⁴⁾C12, sold by Tembec

1. An aqueous binder for mineral fibers, comprising:
at least one ammonium lignosulfonate or one alkali metal or alkaline earth metal salt of lignosulfonic acid, and
at least one carbonyl compound of formula:
R—[C(O)R₁]ₓ (I)
in which:
R represents a saturated or unsaturated and linear, branched or cyclic hydrocarbon radical, a radical including one or more aromatic nuclei which consist of 5 or 6 carbon atoms, a radical including one or more aromatic heterocycles containing 4 or 5 carbon atoms and an oxygen, nitrogen or sulfur atom, it being possible for the R radical to contain other functional groups,
R₁ represents a hydrogen atom or a C₁-C₁₀ alkyl radical, and
x varies from 1 to 10,
said binder being devoid of hydrogenated sugar and of melamine.

2. The binder as claimed in claim 1, wherein R₁ represents a hydrogen atom and x is at most equal to 6.

3. The binder as claimed in claim 2, wherein the carbonyl functional group is provided in the form of an acetal or of a hemiacetal of following formula (II): 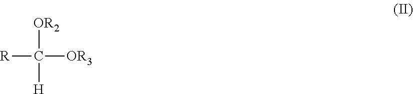
in which:
R₂ represents a C₁-C₁₀ alkyl radical, and
R₃ represents a hydrogen atom or a C₁-C₁₀ alkyl radical.

4. The binder as claimed in claim 2, wherein the carbonyl compound is chosen from the group consisting of acetaldehyde, propionaldehyde, dimethoxyethanal, butyraldehyde, glyoxal, malonaldehyde, succinaldehyde, glutaraldehyde, 2-hydroxyglutaraldehyde, 3-methylglutaraldehyde, adipaldehyde, suberaldehyde, sebacaldehyde, malealdehyde, fumaraldehyde, poly(acroleins), dialdehyde starch, furfural (2-furancarboxyaldehyde), 5-methylfurfural (2-methyl-5-furancarboxyaldehyde), hydroxymethylfurfural (2-hydroxymethyl-5-furancarboxyaldehyde), 2,5-furancarboxydialdehyde, vanillin and vanillin polymers, cinnamaldehyde and cinnamaldehyde polymers, phthalaldehyde, isophthalaldehyde, terephthalaldehyde and the oligomers of following formulae (III) and (IV): 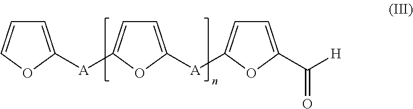
in which:
A represents a divalent —CH₂—, —CH(OH)— or —CH₂—O—CH₂— radical, n varies from 1 to 8, 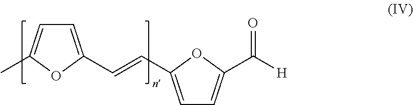
in which n′ varies from 1 to 9.

5. The binder as claimed in claim 1, wherein the ammonium lignosulfonate or the alkali metal or alkaline earth metal salt of lignosulfonic acid represents from 30 to 95% of the weight of the mixture consisting of ammonium lignosulfonate or the alkali metal or alkaline earth metal salt of lignosulfonic acid and the carbonyl compound of formula (I).

6. The binder as claimed in claim 1, further comprising:
at least one vinyl acetate homopolymer or one copolymer of vinyl acetate and of at least one hydrophobic monomer, and
at least one polysaccharide.

7. The binder as claimed in claim 6, wherein the homopolymer or copolymer of vinyl acetate and of at least one hydrophobic monomer is present in an amount at most equal to 15 parts by weight per 100 parts by weight of ammonium lignosulfonate or of alkali metal or alkaline earth metal salt of lignosulfonic acid and of carbonyl compound of formula (I).

8. The binder as claimed in claim 6, wherein the polysaccharide is present in an amount at most equal to 50 parts by weight per 100 parts by weight of ammonium lignosulfonate or of alkali metal or alkaline earth metal salt of lignosulfonic acid and of carbonyl compound of formula (I).

9. The binder as claimed in claim 1, further comprising an ammonium lignosulfonate and at least one compound chosen from phosphorus-containing compounds and ammonium sulfate.

10. The binder as claimed in claim 9, wherein the phosphorus-containing compound and the ammonium sulfate are present in an amount at most equal to 20 parts by weight per 100 parts by weight of ammonium lignosulfonate and of carbonyl compound of formula (I).

11. The binder as claimed in claim 1, further comprising the additives below in the following proportions, calculated on the basis of 100 parts by weight of ammonium lignosulfonate or of alkali metal or alkaline earth metal salt of lignosulfonic acid and of carbonyl compound of formula (I):
0 to 1 part by weight of silane,
0 to 5 parts by weight of a silicone, of a vegetable oil or of a fluorinated compound, and
0 to 5 parts of a plasticizing agent.

12. The binder as claimed in claim 1, further comprising an alkali metal or alkaline earth metal salt of lignosulfonic acid and wherein the binder is devoid of nitrogenous compounds.

13. A mat comprising mineral fibers, wherein the fibers are bonded by the binder as claimed in claim 1.

14. The mat as claimed in claim 13, wherein the mat exhibits a weight per unit area which varies from 10 to 1100 g/m².

15. The mat as claimed in claim 13, wherein the binder represents from 5 to 40% by weight of said mat.

16. The mat as claimed in claim 13, comprising organic fibers in a proportion at most equal to 20% of the weight of the mineral fibers.

17. The binder as claimed in claim 1, wherein the mineral fibers are rock or glass fibers.

18. The binder as claimed in claim 1, wherein the other functional groups include hydroxyl or alkoxy groups.

19. The binder as claimed in claim 18, wherein the other functional groups include methoxy groups.

20. The binder as claimed in claim 4, wherein the carbonyl compound is n-butyraldehyde or bis-vanillin.

21. The binder as claimed in claim 5, wherein the ammonium lignosulfonate or the alkali metal or alkaline earth metal salt of lignosulfonic acid represents from 40 to 80% of the weight of the mixture consisting of ammonium lignosulfonate or the alkali metal or alkaline earth metal salt of lignosulfonic acid and the carbonyl compound of formula (I).

22. The binder as claimed in claim 21, wherein the ammonium lignosulfonate or the alkali metal or alkaline earth metal salt of lignosulfonic acid represents from 50 to 70% of the weight of the mixture consisting of ammonium lignosulfonate or the alkali metal or alkaline earth metal salt of lignosulfonic acid and the carbonyl compound of formula (I).

23. The binder as claimed in claim 11, comprising
0.1 to 0.5 part by weight of silane, and
0.1 to 1 part by weight of a silicone, of a vegetable oil or of a fluorinated compound,
wherein the plasticizing agent is glycerol.

24. The mat as claimed in claim 13, wherein the mineral fibers are rock or glass fibers.

25. The mat as claimed in claim 14, wherein the mat exhibits a weight per unit area which varies from 30 to 350 g/m².

26. The mat as claimed in claim 25, wherein the mat exhibits a weight per unit area which varies from 35 to 75 g/m².

27. The mat as claimed in claim 15, wherein the binder represents from 10 to 30% by weight of said mat.
